(19) United States
(12) Patent Application Publication
(10) Pub. No.: US 2004/0241356 A1
(43) Pub. Date: Dec. 2, 2004

(54) Injection moulded containers

(76) Inventors: Phillippe Bourgoin, Mira (IT); Geoffrey Robert Hammond, Hull (GB)

Correspondence Address: NORRIS, MCLAUGHLIN & MARCUS, 875 THIRD AVE, 18TH FLOOR, NEW YORK, NY, 10022, US

(21) Appl. No.: 10/489,874

(22) PCT Filed: Sep. 16, 2002
(86) PCT No.: PCT/GB02/04205

(30) Foreign Application Priority Data
Sep. 20, 2001 (GB) 0122635.6

(51) Int. Cl. F16L 1/00

(52) U.S. Cl. 428/34.1

(57) ABSTRACT

the present invention relates generally to water-soluble containers made from polymeric foams, and more particularly from microcellular foams, which containers are preferably made by injection moulding, which water-soluble containers contain a detergent composition or a water softening composition, and methods for the production of such water-soluble containers.

The present invention relates generally to water-soluble containers made from polymeric foams, and more particularly from microcellular foams, which containers are preferably made by injection moulding, which water-soluble containers contain a detergent composition or a water softening composition, and methods for the production of such water-soluble containers.

Polymeric foams include a plurality of voids, also called cells, in a polymer matrix. By replacing solid plastic with voids, polymeric foams use less raw material than solid plastics for a given volume. Thus, by using polymeric foams in many applications instead of solid plastics, material costs are reduced.

Microcellular foams have smaller cell sizes and higher cell densities than conventional polymeric foams. Typically, microcellular foams are defined as having average cell sizes of less than 100 microns and a cell density of greater than 10⁶ cells/cm³ of solid plastic. In a typical process for forming microcellular foam (e.g. extrusion), the pressure on a single-phase solution of blowing agent and polymer is rapidly dropped to nucleate the cells. The nucleation rate must be high enough to form the microcellular structure.

WO9808667 describes a method of nucleating polymers containing a blowing agent, the method being useful in extruding polymers having different nucleation patterns in the same extrudate (including generating microcellular foams of cell sizes of less than 50 μm).

CA 1,112,534 discloses automatic dishwashing liquid compositions packaged in a water-soluble film container. characterised in that the container is made of a polymeric foam, preferably a microcellular foam. Preferably the container is made by injection moulding.

The present invention further provides a method of ware washing, comprising use of a container, as defined above, the method entailing introducing the container into a ware washing machine prior or during commencement of the washing process, the container being entirely consumed during the washing process. The ware washing machine may, for example, be a dishwashing or laundry washing machine.

The invention further provides a container, as defined herein, comprising moulding a container from a molten water-soluble polymer, filling the container with a detergent composition (preferably a fabric care, surface care or dishwashing composition) and sealing the container.

Several patents describe aspects of microcellular materials and microcellular processes, U.S. Pat. No. 4,473,665 describes a process for making foamed polymer having cells less than about 100 microns in diameter. In the technique described a material precursor is saturated with a blowing agent, the material is placed under high pressure, and the pressure is rapidly dropped to nucleate the blowing agent and to allow the formation of cells. The material then is frozen rapidly to maintain a desired distribution of microcells. U.S. Pat. No. 5,158,986 describes formation of microcellular polymeric material using a supercritical fluid as a blowing agent. In a batch process a plastic article is submerged at pressure in supercritical fluid for a period of time, and then quickly returned to ambient conditions creating a solubility change and nucleation. In a continuous process, a polymeric sheet is extruded, and then can be run through rollers in a container of supercritical fluid at high pressure, and then exposed quickly to ambient conditions. In another continuous process, a supercritical fluid-saturated molten polymeric stream is established. The polymeric stream is rapidly heated, and the resulting thermodynamic instability (solubility change) creates sites of nucleation, while the system is maintained under pressure preventing significant growth of cells. The material then is injected into a mold cavity where pressure is reduced and cells are allowed to grow.

The blowing agent is suitably any fluid capable of dissolving in the molten polymer, preferably dissolved to saturation or super saturation, and is a gas at ambient conditions (i.e. temperature and pressure), preferred fluids are either a gas or a supercritical liquid, for example CO₂ or N₂.

Desirably the container, apart from its contents, consists essentially of the polymer. It is possible for suitable additives such as plasticizers and lubricants to be included. Plasticizers are generally used in an amount of up to 20 wt %, for example from 15 to 20 wt %, lubricants are generally used in an amount of 0.5 to 5% wt % and the polymer is generally therefore used in an amount of 75 to 94.5 wt %, ideally 75 to 84.5 wt %, based on the total amount of the moulding composition. Suitable plasticizers are, for example, pentaerthyritol such as depentaerythritol, sorbitol, mannitol, glycerine and glycols such as glycerol, ethylene glycol and polyethylene glycol.

The polymeric foam can be composed of any water-soluble polymer, preferably that is crystalline or semi-crystalline. Preferred polymers are; poly(vinylalcohol) [PVOH], poly(vinylpyrollidone) [PVP], modified celluloses (such as hydroxypropyl methylcellulose) [HPMC], polyacrylic acid or an ester thereof, polymaleic acid or an ester thereof, or a copolymer of any thereof. Also included are interpolymers which comprise a blend of any of the above or in addition of another polymer which is also water-soluble.

Examples of preferred polymers are PVOH and cellulose ethers, such as HPMC.

PVOH is a known water-soluble material which is used to prepare water-soluble films for encasing compositions. Cellulose ethers have not in general been used to prepare water-soluble films because they have poor mechanical strength.

The PVOH preferably used to form the container of the present invention may be partially or fully alcoholised or hydrolysed. For example it may be from 40-100%, preferably 70-92%, more preferably about 88%, alcoholised or hydrolysed polyvinylacetate. The polymer such as PVOH or cellulose ether is generally cold water (20° C.) soluble, but may be insoluble in cold water at 20° C. and only become soluble in warm water or hot water having a temperature of, for example, 30° C., 40° C., 50° C. or even 60° C. This parameter is determined in the case of PVOH by its degree of hydrolysis.

In addition it is important that the material is free from water, especially when using an injection moulding process for preparing the container, ideally less than 2 wt % of water is present in the polymer.

For certain applications or uses, polymers soluble in aqueous environments at temperatures as low as 5° C. are also desirable.

Solids such as talc, stearic acid, magnesium stearate, silicon dioxide, zinc stearate, and colloidal silica may also be used as a filling agent to the polymer or to aid its moulding, in addition such additives may act as a nucleating agent as described below. A preferred PVOH which is already in a form suitable for injection moulding is sold in the form of granules under the name CP1210T05 by Soltec Development SA of Paris, France.

The PVOH may be moulded at temperatures of, for example, from 180-220° C., depending upon the formulation selected and the melt flow index required. It can be moulded into containers, capsule bodies, caps, receptacles and closures of the appropriate hardness, texture and solubility characteristics.

The container walls have thicknesses such that the containers are rigid. For example, the outside walls and any inside walls which have been injection moulded independently have a thickness of greater than 100 μm, for example greater than 150 μm or greater than 200 μm, 300 μm, 500 μm or 750 μm. Ideally the container is made up of at least the following; a receptacle part (for holding the composition) and a closure part (for sealing the receptacle part). Preferably, the closure part is of a thinner material than the receptacle part. Thus, typically, the closure part is of thickness in the range 10 to 200 μm, preferably 50 to 100 μm, and the wall thickness of the receptacle part is in the range 150 to 1500 μm, preferably 250 to 1000 μm. The closure part may, however, also have a wall thickness of 10 to 1000 μm, such as 300 to 700 μm.

We have found that by the use of the processes described herein much thinner walls are achievable due to the influence of the blowing agent (gas or supercritical liquid) on the flow index of the molten polymer.

Preferably, the closure part dissolves in water (at least to the extent of allowing the detergent composition in the receptacle part to be dissolved by the water; and preferably completely) at 40° C. in less than 5 minutes, preferably in less than 2 minutes.

The receptacle part and the closure part could be of the same thickness or different thicknesses. The closure part may, for example, be of higher solubility than the receptacle part, in order to dissolve more quickly.

Preferably the closure part is simply a film made from a water-soluble polymer.

Preferably, the container is generally cuboid in its external shape, with the top wall being formed by the closure part, and with the side walls and base wall being formed by the receptacle part. One advantage of the injection moulding process described herein is that any number of different shapes may be easily produced.

Preferably, a container of the invention is manufactured by forming an array of receptacle parts, each receptacle part being joined to adjacent receptacle parts, and being separable from them by a snap or tear action. The array is preferably one which has columns and rows of the receptacle parts. The receptacle parts may be separated by frangible webs of the water-soluble polymer such as PVOH or a cellulose ether.

Alternatively, the receptacle parts may be manufactured with the aforementioned flanges, such that they are separated from each other by a line of weakness. For example the material may be thinner, and so able to be broken or torn readily. The thinness may be a result of the moulding process or, preferably, of a later scoring step.

In the manufacturing method, the array, formed by injection moulding, is fed to a filling zone, and all the receptacle parts are charged with the washing composition. A sheet of a water-soluble polymer such as PVOH or a cellulose ether may then be secured over the top of the array, to form the closure parts for all the receptacle parts of the array. The array may then be split up into the individual washing capsules, prior to packaging, or it may be left as an array, for packaging, to be split by the user. Preferably, it is left as an array, for the user to break or tear off the individual washing capsules. Preferably, the array has a line of symmetry extending between capsules, and the two halves of the array are folded together, about that line of symmetry, so that closure parts are in face-to-face contact. This helps to protect the closure parts from any damage, between factory and user. It will be appreciated that the closure parts are more prone to damage than the receptacle parts. Alternatively two identical arrays of washing capsules may be placed together with their closure parts in face-to-face contact, for packaging.

In some embodiments of the invention the container, capsule or receptacle part may define a single compartment. In other embodiments of the invention the container, capsule or receptacle part may define two or more compartments, which contain different products useful in a washing process. In such a situation a dividing wall or walls of the compartments preferably terminate at the top of the container, capsule or receptacle part i.e. in the same plane as the top edges of the side walls, so that when the receptacle part is closed by the closure part the contents of the compartments cannot mix. The container, capsule or receptacle part may be provided with an upstand, preferably spaced from the side walls thereof, and preferably of generally cylindrical shape. If wished, the remaining volume of the container, capsule or receptacle part can be divided into two or more parts by means of walls extending between the upstand and the side walls.

International patent publication no. WO 98/08667 (Burnham et al.) provides methods and systems for producing microcellular material, and microcellular articles. In one method of Burnham et al., a fluid, single phase solution of a precursor of foamed polymeric material and a blowing agent is continuously nucleated by dividing the stream into separate portions and separately nucleating each of the separate portions. The divided streams can be recombined into a single stream of nucleated, fluid polymeric material. The recombined stream may be shaped into a desired form, for example, by a shaping die. In some of the methods, pressure drop rate is an important feature and techniques to control this and other parameters are described.

Conventional foam processes, in some cases, incorporate nucleating agents. A “nucleating agent” is a dispersed agent, such as talc or other filler particles, added to a polymer and able to promote formation of nucleation sites from a single-phase, homogeneous solution of the blowing agent in the molten polymer. A “filler” is a dispersed particle added to replace solid plastic.

The nucleating agents can be any of a variety of materials and in any number of forms, as known in the art. In certain embodiments, the nucleating agents are inorganic solids such as those commonly used in the art, for example talc, calcium carbonate (CaCO₃), titanium oxide (TiO₂), barium sulphate (BaSO₄), and zinc sulfide (ZnS). In certain embodiments, organic solids, such as cellulosic fibres, may also function as nucleating agents. In particular, microcellular foams including both talc and titanium oxide have been produced.

Typically, the nucleating agents are particles, though in some cases the nucleating agents may be fibrous or have other forms. The nucleating particles can have a variety of shapes such as spherical, cylindrical, or planar. Generally, the particles have a size in the range of about 0.01 microns to about 10 microns, and more typically between about 0.1 microns and 1.0 microns. In some embodiments, the particles may be surface treated with a surfactant to enhance dispersibility within polymer melt and to prevent particle agglomeration. In some cases, the nucleating agents, depending on their composition, may also function as pigments, flame-retardants or any other typical additive. The nucleating agents may also function as fillers. That is, the nucleating agents replace solid plastic in a non-negligible amount which, in certain embodiments, leads to cost savings because filler is less expensive than the solid plastic. In certain embodiments, the agents also may enhance the mechanical properties of the microcellular foam. In some cases, the particles may enhance crystallinity. In particular, nucleating agents are incorporated into the polymer melt typically at levels less than 1% by weight of polymeric melt to lower the energy for cell nucleation. The dispersion of nucleating agents within the polymer mixture is often times critical in forming a uniform cell structure. In some cases, higher levels (greater than 5% by weight) are not used because of the agglomeration of the particles that can lead to non-uniform cell structures having anomalous large cells. The following U.S. Patents describe the use of nucleating agents in foam processes.

U.S. Pat. No. 3,491,032 (Skochdopole et al.; Jan. 20, 1970) describes a process for making cellular polymer materials. In a process of Skochdopole, finally divided solid materials such as calcium silicate, zinc stearate, magnesium stearate and the like can advantageously be incorporated with the polymer or gel prior to expanding the same. Such finely divided materials aid in controlling the size of the cells, and are employed in amounts of from about 0.01% to about 2.0% by weight of the polymer.

U.S. Pat. No. 5,116,881 (Park et al.; May 26, 1992) describes polypropylene foam sheets and a process for their manufacture. In a process of Park, a nucleating agent, is used to create sites for bubble initiation. It is preferred that the nucleating agent have a particle size in the range of 0.3 to 5.0 microns. Ideally the concentration of the nucleating agent should be less than 1% by weight of the polymer. Concentrations of nucleating agents greater than 5% by weight of the polymer generally leads to agglomeration, or insufficient dispersion of nucleating substance so that the diameter of the cell size becomes too great. The polymeric material preferably includes a semi-crystalline water-soluble polymer, and, preferably, a nucleating agent in an amount between 0.1 and 7% weight of the polymeric material. The method further includes moulding a container from the polymeric material, preferably by injection moulding. The process further includes the step of inducing a pressure drop rate of less than 1.0 GPa/s in the solution of blowing agent and polymeric material during moulding.

Fillers in polymeric foams are typically added in amounts of at least 20% by weight polymeric material, and in many cases greater than 30% by weight. In international patent publication no. WO 98/08667 (Burnham et al.) described above, Burnham describes examples of microcellular material that include filler levels in an amount of at least 10% by weight polymeric material, other examples include filler levels in an amount of at least about 25% by weight polymeric material, other examples include filler levels in an amount of at least about 35% by weight polymeric material, and still other examples include filler levels of at least about 50% by weight polymeric material.

By the use of the term “polymeric foam” we mean a polymer having a plurality of cell voids and having an average cell void size of less than 150 microns, ideally less than 90 microns (“microcellular foam”). A preferred cell void size for a microcellular foam is less then 70 microns.

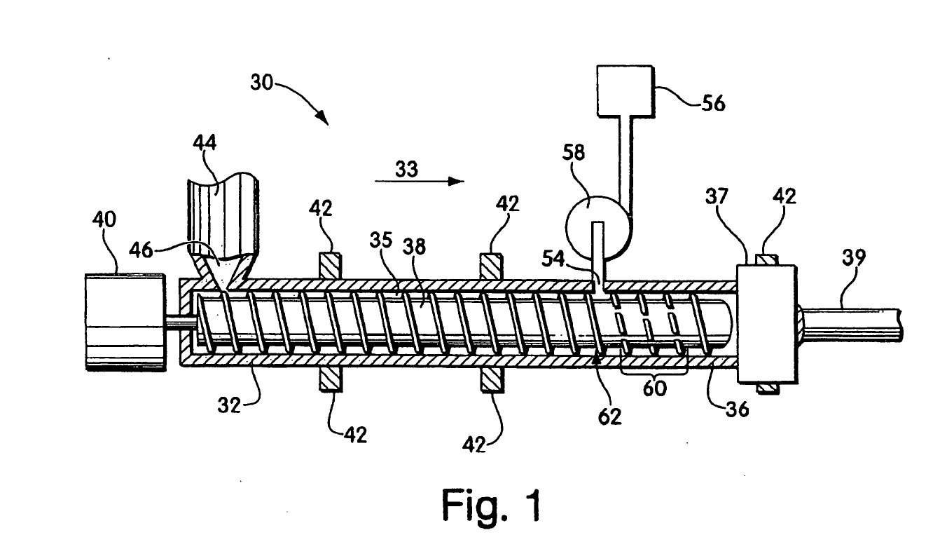

FIG. 1 illustrates an extrusion system for producing polymeric foam.

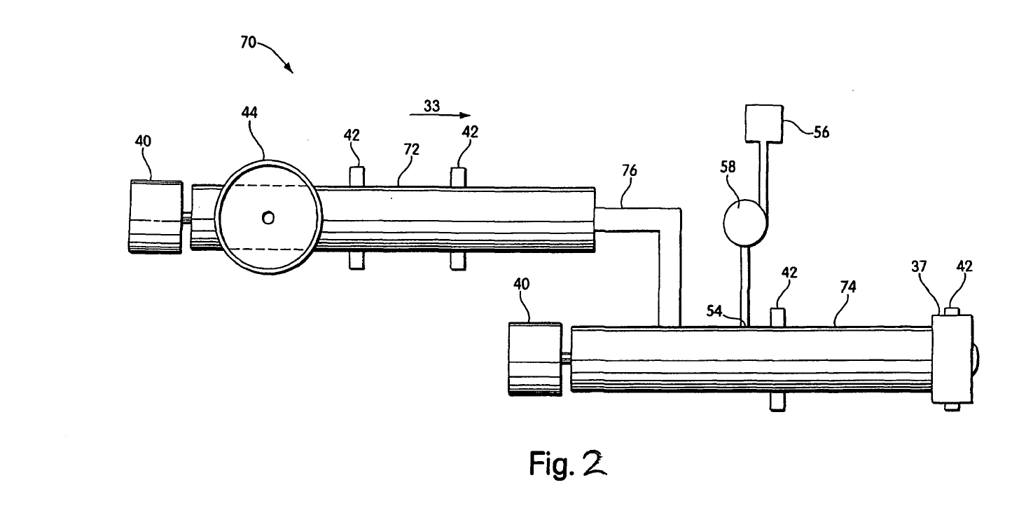

FIG. 2 illustrates a multihole blowing agent feed orifice arrangement and extrusion screw.

The various embodiments and aspects of the invention will be better understood from the following definitions. As used herein, “nucleation” defines a process by which a homogeneous, single-phase solution of polymeric material, in which is dissolved at least one blowing agent, undergoes formations of clusters of molecules of the species that define “nucleation sites”, from which cells will grow. That is, “nucleation” means a change from a homogeneous, single-phase solution to a multi-phase mixture in which, throughout the polymeric material, sites of aggregation of at least several molecules of blowing agent are formed. Thus “nucleation sites” do not define locations, within a polymer, at which nucleating agent particles reside. “Nucleated” refers to a state of a fluid polymeric material that had contained a single-phase, homogeneous solution including at least one blowing agent, but, following a nucleating event (typically thermodynamic instability) contains nucleation sites. “Non-nucleated” refers to a state defined by a homogeneous, single-phase solution of polymeric material and dissolved at least one blowing agent, absent nucleation sites. A “non-nucleated” material can include nucleating agent such as talc.

A preferred polymer is PVOH. As far as we are aware the formulation of polymer foam water-soluble containers for use in ware-washing machines is not previously known. The invention offers several advantages, apart from savings in the cost of goods, in that the physical properties of parts of the container can be modified by using different levels of foam and the processibility of the molten polymer is improves, especially for injection moulding. By use of these techniques timed release can be achieved if the contents into the ware-washing machine can be achieved so as to maximise cleaning efficiency of the contents.

Optionally, the foam composition may also include other additives, as known in the art, in addition to the nucleating agents. Such additives may be processing aids such as plasticizers (e.g. low-molecular weight organic compounds), lubricants, flow enhancers, and anti-oxidants. In many preferred cases, the polymeric material is essentially free of residual chemical blowing agents and reaction by products because only physical blowing agents are used in the process.

Referring to FIG. 1, an extrusion system 30 for the production of polymeric foam is illustrated schematically. The extrusion system includes a screw 38 that rotates within a barrel 32 to convey, in a downstream direction 33, polymeric material in a processing space 35 between the screw and the barrel. The polymeric material is extruded through a die 37 fluidly connected to processing space 35 and fixed to a downstream end 36 of barrel 32. Die 37 is configured to form an extrudate 39 into the mould, as described further below.

Typically, the polymeric material is gravity fed into polymer processing space 35 through orifice 46 from a standard hopper 44. The polymeric material, generally, is in pelletized form.

As well known in the art, in some cases, the nucleating agent may be added in a concentrate blend with the semicrystalline polymer in pellet form. That is, nucleating agent particles are dispersed in pellets of semicrystalline polymer in concentrated percentages, for example 40% by weight. The concentrated pellets are blended with suitable amounts of semicrystalline pellets to produce a polymeric material having between 2.5 and 7 weight percent nucleating agent. In this fashion, the percentage of talc in the polymeric material composition can be adjusted by controlling the ratio of concentrate to pure polymer pellets. In other embodiments, also well known to those skilled in the art, nucleating agents in particulate form may be added directly to the polymeric material. Any other techniques well known in the art may also be employed for incorporating the nucleating agents into the polymer composition in controllable amounts.

Extrusion screw 38 is operably connected, at its upstream end, to a drive motor 40 which rotates the screw. Although not shown in detail, extrusion screw 38 includes feed, transition, gas injection, mixing, and metering sections as described further below.

Positioned along extrusion barrel 32, optionally, are temperature control units 42. Control units 42 can be electrical heaters, can include passageways for temperature control fluid, or the like. Units 42 can be used to heat a stream of pelletized or fluid polymeric material within the extrusion barrel to facilitate melting, and/or to cool the stream to control viscosity, skin formation and, in some cases, blowing agent solubility. The temperature control units can operate differently at different locations along the barrel, that is, to heat at one or more locations, and to cool at one or more different locations. Any number of temperature control units can be provided. Temperature control units 42 can also optionally be used to heat die 37.

From hopper 44 pellets are received into the feed section of screw and conveyed in a downstream direction in polymer processing space 35 as the screw rotates. Heat from extrusion barrel 32 and shear forces arising from the rotating screw, act to soften the pellets within the transition section. Typically, by the end of the first mixing section the softened pellets have been gelated, that is welded together to form a uniform fluid stream substantially free of air pockets.

The blowing agent is introduced into the polymer stream through a port 54 in fluid communication with a source 56 of a physical blowing agent. The port can be positioned to introduce the blowing agent at any of a variety of locations along the extrusion barrel 32. Preferably, as discussed further below, the port introduces blowing agent at the gas injection section of the screw, where the screw includes multiple flights.

Any of a wide variety of physical blowing agents known to those of ordinary skill in the art such as hydrocarbons, chlorofluorocarbons, nitrogen, carbon dioxide, and the like can be used in connection with this embodiment of the invention. According to a preferred embodiment, source 56 provides carbon dioxide as a blowing agent. In another preferred embodiment, source 56 provides nitrogen as a blowing agent. In particularly preferred embodiments solely carbon dioxide or nitrogen is respectively used. A pressure and metering device 58 typically is provided between blowing agent source 56 and port 54. Blowing agents that are in the supercritical fluid state in the extruder are especially preferred, in particular supercritical carbon dioxide and supercritical nitrogen.

Device 58 can be used to meter the blowing agent so as to control the amount of the blowing agent in the polymeric stream within the extruder to maintain a level of blowing agent at a level. In a preferred embodiment, device 58 meters the mass flow rate of the blowing agent. The blowing agent is generally less than about 15% by weight of polymeric stream and blowing agent. Surprisingly, in some embodiments, it has been discovered that the present microcellular semicrystalline foam using relatively low blowing agent percentages. The presence of the nucleating agent is believed to enhance the driving force for nucleation thus enabling the production of microcellular foam at low blowing agent percentages, for example less than 1.5 percent blowing agent by weight of polymeric stream and blowing agent. In preferred embodiments, the process involves adding less than 1.0 weight percent blowing agent, and in other preferred cases, the process involves adding less than 0.5 percent, by weight of polymeric stream and blowing agent, while in other embodiments the process involves adding less than 0.1 percent, by weight of polymeric stream and blowing agent.

Referring again to FIG. 1, a mixing section of screw 38, following the gas injection section, is constructed to mix the blowing agent and polymer stream to promote formation of a single phase solution of blowing agent and polymer. The mixing section includes unbroken flights which break up the stream to encourage mixing. Downstream the mixing section, a metering section builds pressure in the polymer-blowing agent stream prior to die 37.

The systems of FIGS. 1 and 2 are modified, as known in the art, to function as injection moulding systems. Generally, injection moulding systems do not include an extrusion die 37, but rather include a pathway fluidly connected to the polymer processing space through which the polymer and blowing agent solution is injected into the mould.

As the extrudate cools in the atmosphere and becomes more solid, cell growth is restricted. In certain embodiments, it is advantageous to provide external cooling means to speed the cooling rate of the extrudate. For example, in these embodiments, cooling may be accomplished by blowing air on the extrudate, contacting the extrudate with a cool surface, or submerging the extrudate in a liquid medium.

Referring to FIG. 2, an alternative extrusion system 70 for producing microcellular foam in accordance with the invention includes a tandem extruder line. The tandem line includes a primary extruder 72 and a secondary extruder 74 arranged in parallel configuration and connected through a transfer pipe 76. As described above, pellets are supplied into the primary extruder through hopper 44. In some embodiments, the secondary extruder includes blowing agent injection port 54, as illustrated. In other embodiments, the primary extruder includes the blowing agent injection port.

Injection moulding techniques are well known to the skilled person are described subsequently in the literature (see, for example a good summary is provided in “The Wiley Encyclopaedia of Packaging Technology” Wiley Interscience 1986). Special techniques, which use are preferred features of the invention for producing containers, which may have more than one type of polymer, are described herein.

Simultaneous Injection Moulding

1) two or more polymers are molten mixed and injected into a mould

2) two or more polymers are injected into a mould through more than one gate, each gate allowing simultaneous injection of a single polymer or molten mix into the mould

3) simultaneously injection moulding two or more compartments and then joining the compartments together.

Sequential Injection Moulding

1) multi-component injection moulding

2) sandwich injection moulding

3) sequentially injection moulding two or more compartments and then joining compartments together.

Multi-component injection moulding covers two distinct processes

A) injection moulding a polymer or molten polymer mix into a mould, removing the solid polymer and inserting into a second mould and injection moulding a second polymer or polymer mix into the second mould.

B) injection moulding a polymer or molten polymer mix into a part of a mould, injection moulding a second polymer or molten polymer mix into a further part of the mould.

Steps A) and B) may be repeated more than once and may be mixed. It will be appreciated by the skilled person that the first injection moulded polymer must have sufficient properties to survive the pressure and temperature conditions of the second, or subsequent, injection moulding.

For step B) the first polymer or molten mix may be prevented from entering parts of the mould by any physical means, such as, gates, gravity, positive or negative pressure.

Sandwich injection moulding (or sometimes called skin-core injection moulding) comprises injection moulding a polymer or molten polymer mix into a mould until it is partially filled and then injecting a second polymer or molten polymer mix into the same mould through the same gate to form the core. An additional step of sealing the core may be performed. This is particularly preferred as it offers particular advantages due to the poor surface finish of foamed polymers and will produce a more aesthetically pleasing product.

A further technique that can be used is to coat part or the entire container, the container being moulded from any water-soluble polymer in accordance with invention, with a polymer which is water-soluble. Coating may be achieved by dipping the container into a solution of polymer or in molten polymer or by spray coating of a solution of polymer or molten polymer. It will be appreciated that polymers that are water-soluble but which cannot be injection moulded can be used, such as, preferably, PVNO. Coating offers particular advantages due to the poor surface finish of foamed polymers and will produce a more aesthetically pleasing product.

It will be appreciated that any combination of simultaneous and sequential injection moulding may be used.

1. A rigid container made of a material that will dissolve in an aqueous solution in which is partially or completely enclosed by the container a detergent composition, characterised in that the container is made of a polymeric foam having a plurality of cell voids having an average cell void size of less than 150 microns.

2. A rigid container according to claim 1 wherein the water-soluble polymer is selected from poly(vinylalcohol), poly(vinylpyrollidone), modified cellulose, polyacrylic acid or an ester thereof, polymaleic acid or an ester thereof, or a copolymer of any thereof, or an interpolymer which comprises a blend of any of the above.

3. A rigid container according to claim 1 wherein the container walls have a thickness of between 250 to 1000 μm.

4. A rigid container according to claim 1 wherein the polymeric foam is a microcellular foam having an average cell void size of less than 90 microns.

5. A rigid container according to claim 1 wherein the polymeric foam is a microcellular foam having an average cell void size of less than 70 microns.

6. A rigid container according to claim 1 which is made by injection moulding.

7. A method of ware washing, comprising use of a rigid container according to claim 1, the method comprising the step of:
introducing the container into a ware washing machine prior to or during commencement of the washing process, wherein the container is entirely consumed during the washing process.

8. A process for preparing a rigid container according to claim 1, comprising the steps of:
moulding a foam container from a molten water-soluble polymer in which a blowing agent is dissolved,
filling the container with a detergent composition, and,
sealing the container.

9. A process according to claim 8 wherein the molten water-soluble polymer has a blowing agent.

10. A process according claim 9 wherein the blowing agent is selected from CO₂ or N₂.

11. A process according to claim 8 wherein the molten water-soluble polymer includes a semi-crystalline polymer.

12. A process according to claim 8 wherein there container is moulded by injecting the molten water-soluble polymer into a mould.

13. A rigid container according to claim 2 wherein the container walls have a thickness of between 250 to 1000 μm.

14. A rigid container according to claim 2 wherein the polymeric foam is a microcellular foam having an average cell void size of less than 90 microns.

15. A rigid container according to claim 2 wherein the polymeric foam is a microcellular foam having an average cell void size of less than 70 microns.

16. A rigid container according to claim 2 which is made by injection moulding.

17. A process according to claim 9 wherein the molten water-soluble polymer has a blowing agent dissolved in it to saturation.

18. A process according to claim 11 wherein the molten water-soluble polymer includes a semi-crystalline polymer and further wherein 0.1 to 7% weight of the total polymeric material is a nucleating agent.
